(19) United States
(12) Patent Application Publication
(10) Pub. No.: US 2016/0366903 A1
(43) Pub. Date: Dec. 22, 2016

(54) INTELLIGENT OXYGEN DEVICE AND METHOD OF CONVERSION OF SUMMER-AUTUMN TEA TO INSTANT BLACK TEA POWDER VIA OXIDATION REACTION

(71) Applicant: JIANGSU UNIVERSITY, Jiangsu (CN)

(72) Inventors: Quansheng CHEN, Jiangsu (CN); Dongliang ZHANG, Jiangsu (CN); Qin OUYANG, Jiangsu (CN); Pengxiang YUE, Jiangsu (CN); Jiewen ZHAO, Jiangsu (CN)

(73) Assignee: Jiangsu University, Jiangsu (CN)

(21) Appl. No.: 15/115,564

(22) PCT Filed: Apr. 29, 2015
(86) PCT No.: PCT/CN2015/077741

§ 371 Date: Jul. 29, 2016

(30) Foreign Application Priority Data
Feb. 2, 2015 (CN) 201510052747.6

(51) Int. Cl. A23F 3/08; G01N 21/25

(52) U.S. Cl. CPC A23F 3/08; G01N 21/255

(57) ABSTRACT

The invention involves a method and a device that converting the summer-autumn tea concentrate to instant powdered black tea by oxidation reaction. The method is comprised of the following steps: pushing the summer-autumn tea concentrate and oxygen into a long spiral pipe, making them flow, impact, and mix in a high speed which can achieve a high efficient oxidation; the intelligent control of the oxidation process can be realized by the change of the color of the concentrate in the oxidation process; the color value of the concentrate can be detected in real time by peristalsis pump, which flows into the color detection channel based on the multi spectral flash LED light transmission technology; the oxidation can be stopped immediately when the detected chromatic value is within the range of the preset target chromatic value. The patent also provides a device for aerating oxygen, including summer-autumn tea concentrate liquid storage tank, gas-liquid mixing pipe loop and color pipeline detection circuit. The process and the device can realize the oxidation of summer-autumn tea concentrate in a fast, uniform and sufficient way, and can also achieve the process that can improve the quality of instant black tea.

### FIELD OF THE INVENTION

The invention involves processing technology and equipment of tea, specifically the method and device used for introducing for the conversion of summer and autumn tea concentrate to instant powdered black tea.

### BACKGROUND OF THE INVENTION

Summer-autumn tea, produced in summer and autumn, has a bitter and poor taste, low price with low economic benefits as a result of its higher internal polyphenols content. In modern technology, summer-autumn tea leaves are extracted, concentrated. It is then aerated for oxidation, to produce instant powdered black tea with bright color and special taste.

This method of oxidation has poor uniformity when ventilating oxygen, and has no guarantee that the tea polyphenols of would be uniformly oxidized to achieve homogeneous tea content. This way to oxidation has a poor uniformity when ventilating oxygen, which has no guarantee that the polyphenols of tea oxidation homogeneously, and it is affected by the level of workers, personal feelings and other factors. Thus, it is difficult to ensure the stability of the quality of oxidation product, and lead to some problems of instant black tea, such as low product quality, the instability of the quality and so on, which has become a bottleneck restricting the development of instant black tea.

During the oxidation process of black tea, polyphenols in the tea have enzyme catalyzed oxidation reaction with oxygen, and produce a series of oxidation, polymerization, condensation reactions which generate a colored oxide product, such as theaflavins, thearubigins and theabrownins, along with the other compounds of chemical reaction to form a unique flavor and aromas quality of black tea. The aflavins can affect the brightness and the freshness degrees of the tea; and the thearubigins determines the tea concentration and color. The color changes of the tea directly reflect content changes of theaflavins and thearubigins, thus can be used to judge the degree of oxidation of black tea.

### SUMMARY OF THE INVENTION

The purpose of the invention is to provide the method and device used for monitoring the oxidation color of summer-autumn tea concentrate during the oxidation process so as to achieve precise monitoring in oxidation process and improve the quality of instant black tea.

In order to achieve the purpose of the patent above mentioned, a kind of intelligent oxygen method that converts summer-autumn tea concentrate to instant powdered black tea is adopted by the technical scheme of the patent and it is comprised of the following steps: S1: installing gas-liquid mixed pipeline circuit and color detection pipeline loop on the summer-autumn tea liquid storage tank; S2: the summer-autumn tea concentrate in the gas-liquid mixed pipeline loop mix with the airflow and then flow along the mentioned gas-liquid mixed pipeline loop back to the summer-autumn tea liquid storage tank; the color on-line detection device of summer-autumn tea concentrate is installed on the mentioned color detection pipeline loop and the summer-autumn tea concentrate in the stated color detection pipeline loop flow back to the summer-autumn tea liquid storage tank after being extracted chromatic value by the stated color on-line detection device; S3: reading the chromatic value of summer-autumn tea concentrate and closing the stated gas-liquid mixed pipeline loop if the chromatic value is in the range of the target color value, otherwise, returning step S2.

In the above scheme, the gas-liquid mixed pipeline loop comprises a length of a spiral pipe, and the stated summer-autumn tea concentrate flow in the spiral pipe at a high speed after mixing with airflows.

In the above scheme, the mentioned color on-line detection device includes flash frequency LED light source, color detection channel, single point silicon detector and control terminal; the color detection channel is on the color pipeline detection circuit, the flash frequency of LED light source and the color detection channel are connected to the single silicon detector, the single point silicon detector is connected to the control terminal.

In the above scheme, the flash frequency LED light source is a hollow sphere with three groups of luminous body inside, and each group of luminous body is composed of three kinds of light sources, red, green and blue, which are in the same ring. The light path of the color detection channel and the single silicon detector passes through the ring center surrounded by luminous body inside the hollow sphere.

In the above scheme, each group of luminous body brightens for 1 ms in accordance with the color of red, green, and blue respectively and repeats once every 1 minutes.

In addition, the invention also provides a device for dissolving oxygen, includes summer-autumn tea concentrate liquid storage tank, which is equipped with gas-liquid mixing pipe loop and color pipeline detection circuit. The diaphragm liquid pumps, which can extract summer-autumn tea concentrate from the liquid storage tank, and diaphragm air pump, which can compress air, are installed on the gas-liquid mixed loop pipe, and the tea concentrates can flow back to the storage tank when it is mixed with air. The color detection pipeline circuit is provided with a micro peristalsis pump, a flow meter and a color detection channel. The two ends of the color detection channel are respectively provided with a flash frequency LED light source and a single point silicon detector.

Further, the gas-liquid mixing pipe loop is also installed with a coiled pipe, and the summer-autumn tea concentrated liquid and air can be pressed into the spiral pipe at a high speed after they mix with each other.

Further, the color detection channel, the flash frequency LED light source and the single point silicon detector are connected by straight fiber.

Further, the outer horizontal direction of the color detection channel is provided with two interface flanges which are used to connect the straight fiber. The interior of the color detection channel is provided with a quartz plate, and the upper and the lower of the quartz plate are respectively provided with a hose interface for connecting the rubber hose; The the outer wall of the color detection channel and the outer wall of the quartz plate are inlaid with two collimator lenses.

Further, the flash frequency LED light source is a hollow sphere with three groups of luminous body inside and each group of luminous bodies is composed of three kinds of light sources, red, green and blue, which are in the same ring. The axis line of straight fiber (10) passes through the ring center surrounded by luminous body inside the hollow sphere.

The patent has some beneficial effects. For one thing, using the special spiral pipe type dissolved oxygen device to make air through tea extracts and to mix them uniformly can make the polyphenols of summer-autumn tea extracts fully oxidized, which can guarantee the quality of instant black tea products uniform and stable. For another thing, using the color detection device based on multi spectral flash frequency LED light transmission technology to detect color changes of summer-autumn tea concentrate in real-time can precisely determine the moderate oxidation time of the concentrate, which can guarantee the quality of instant black tea after oxidation. Polyphenols of tea can be oxidized more uniformly and stably, and it will be more accurate and scientific to grasp moderate oxidative point and to improve product quality.

### BRIEF DESCRIPTION OF THE DRAWINGS

FIG. 1 is the schematic of intelligent dissolved oxygen device about the process that oxides summer-autumn tea into instant powdered black tea.

FIG. 2 is the LED light source structure diagram.

FIG. 3 is the structure diagram of color detection device.

FIG. 4 shows the variation of the color of summer-autumn tea concentrate during oxidation process in CIE L*a*b* color space.

Diagram: 1 summer-autumn tea liquid storage tank, 2 micro peristalsis pump, 3 color detection channel, 4 single point silicon detector, 5 flash frequency LED light source, 6 control terminal, 7 diaphragm fluid pump, 8 diaphragm air pump, 9 spiral pipe, 10 straight fiber, 11 rubber hose, 12 flow meter, 13 hose interface, 14 quartz plate, 15 collimator lens, 16 interface flange.

### DESCRIPTION OF THE PREFERRED EMBODIMENTS

The following is the further details of the technical scheme of the invention with drawings and concrete implementation method. The invention has the versatility for oxygen oxidation of summer-autumn tea concentrate, monitoring of color value in the oxidation process, and control of moderate oxidative. The implementation of this case takes summer and autumn green tea (roasted tea) concentrate as the experimental object, and other types of green tea can refer to this example to extract oxidation.

The method and device to dissolve oxygen with spiral pipe is adopted to promote the uniform oxidation of summer-autumn tea concentrate. The color detection device based on multi spectrum flash frequency LED light transmission technology is adopted to monitor color changes of summer-autumn tea concentrate and it will be oxidized moderately when the color meets the qualification. The specific technical solutions are as follows:

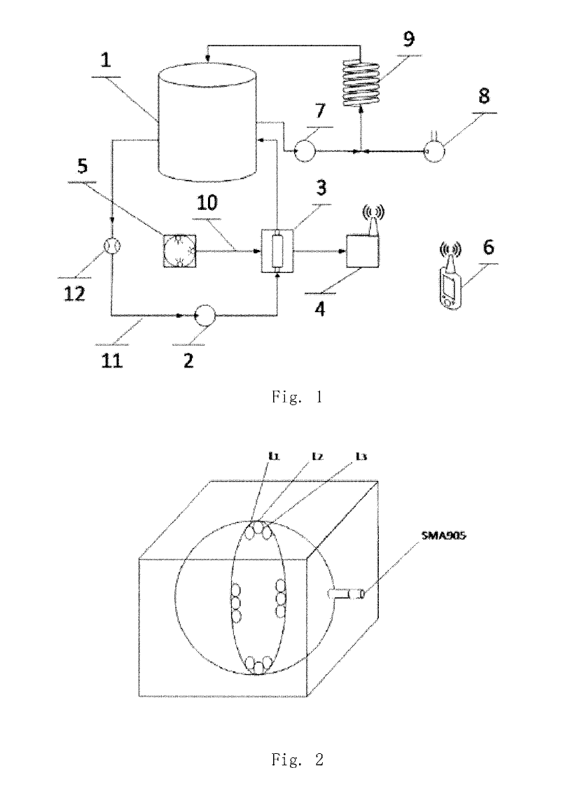

As shown in FIG. 1, the dissolved oxygen device with spiral pipe mainly includes diaphragm fluid pump 7, diaphragm air pump 8, spiral pipe 9. Summer-autumn tea concentrate extracted by diaphragm fluid pump 7 from storage tank 1 and air compressed by diaphragm air pump 8 are driven into spiral pipe 9. Spiral pipe type 9 makes the fluid inside the tube to form turbulent flow, so summer-autumn tea concentrate and oxygen in the compressed air can have a collision and be mixed fully, which makes the summer-autumn tea concentrate fully oxidized. The color detection device based on multi spectral flash frequency LED optical transmission technology mainly includes flash frequency LED light source 5, color detection channel 3, single point silicon detector 4, straight fiber 10, control terminal 16, micro peristalsis pump 2, flow meter 12 and rubber hosel 1. The liquid storage tank 1, the flow meter 12, the micro movement pump 2, and the color detection channel 3 are connected with the rubber hose 11 according to the order of FIG. 1, which forms the sampling circuit. Flash frequency LED light source 5, color detection channel 3, and single point silicon detector 4 are connected through the straight fiber with SMA905 standard interface. Single point silicon detector 6 and control terminal 4 are connected by wireless.

As shown in FIG. 2, there is a hollow sphere whose enwall is coated with barium sulfate diffuse reflection coating inside the flash frequency LED light source 5, and it's effect is similar to the integral ball that can diffuse the light source lamp. Inside the sphere are three light sources L1, L2, L3, of different colors and the horizontal axis of the sphere is cut a small cave that can connect standard SMA905 interface as the output channel. Three kinds of luminous source, L1, L2, L3, brightens for 1 ms in accordance with the color of red, green, and blue respectively and repeats once every 1 minutes.

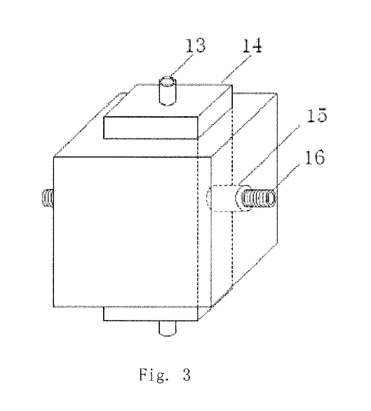

As shown in FIG. 3, the outer horizontal direction of the color detection channel 3 is provided with two interface flanges 16 which are used to connect the straight fiber 10. The interior of the color detection channel 3 is provided with a quartz plate 14, and the upper and the lower of the quartz plate 14 are respectively provided with a hose interface 13 for connecting the rubber hose; The outer wall of the outer wall of the color detection channel 3 and the outer wall of the quartz plate are inlaid with two collimator lenses 15.

At the beginning of dissolving oxygen, micro peristaltic pump 2 extracts summer-autumn tea concentrate from the liquid storage tank 1 and then injects it into color detection channel 3 with liquid flowmeter 12 monitoring liquid flow rate in the pipeline, and finally, summer-autumn tea concentrate flows back to the liquid storage tank 1 through the quartz cuvette in the color detection channel 3. The light emitted by the flash frequency LED light source 5 is illuminated on the colorimetric plate through the straight fiber 10 which is connected with the SMA905 interface flange of the color detection channel 3, and the light through the summer-autumn tea concentrate is received by single point silicon detector 4 whose intensity value in the red, green and blue light represents the color value, R, G and B of summer-autumn tea concentrate, and finally, the R, G and B values are transmitted to the control terminal through the 2.4 GHZ wireless transmission protocol. The RGB color mode is dependence on device and it's linearity of the perception is low which does not conform to the human visual characteristics and is only used for physical device display storage. CIE L * a * b * is the perfect color model to describe all colors that visible to the human eye, and uniform change in the L * a * b * model correspond to the uniform change in color perception, so it is necessary to transform RGB values into the CIE L * a * b * value. The conversion of RGB to L*a*b* CIE must firstly be converted to XYZ three stimulus value, then converted to L*a*b* CIE value, and finally to determine whether to enter the appropriate range of oxidation. The calculation formula is as follows:

### RGB→XYZ:

X=var_R*0.4124+var_G*0.3576+var_B*0.1805

Y=var_R*0.2126+var_G*0.7152+var_B*0.0722

Z=var_R*0.0193+var_G*0.1192+var_B*0.9505

Above the formula,

$${var}_{—} R = \{ \begin{matrix}{( \frac{\frac{R}{255} + 0.055}{1.055} )}^{2.4} , ( \frac{R}{255} > 0.04045 ) \\ \frac{R}{255 * 12.92} , ( \frac{R}{255} \leq 0.04045 )\end{matrix} \\ {var}_{—} G = \{ \begin{matrix}{( \frac{\frac{G}{255} + 0.055}{1.055} )}^{2.4} , ( \frac{G}{255} > 0.04045 ) \\ \frac{G}{255 * 12.92} , ( \frac{G}{255} \leq 0.04045 )\end{matrix} \\ {var}_{—} B = \{ \begin{matrix}{( \frac{\frac{B}{255} + 0.055}{1.055} )}^{2.4} , ( \frac{B}{255} > 0.04045 ) \\ \frac{B}{255 * 12.92} , ( \frac{B}{255} \leq 0.04045 )\end{matrix}$$

### XYZ→CIE-L*a*b*:

CIE-L*=(116*var_Y)−16

CIE-a*=500*(var_X−var_Y)

CIE-b*=200*(var₋Y−var_Z)

Above the formula,

$${var}_{—} X = \{ \begin{matrix}{( \frac{X}{95.047} )}^{\frac{1}{x}} , ( \frac{X}{95.047} > 0.008856 ) \\ \frac{7.787 * X}{95.047} + \frac{16}{116} , ( \frac{X}{95.047} \leq 0.008856 )\end{matrix} \\ {var}_{—} Y = \{ \begin{matrix}{( \frac{Y}{100} )}^{\frac{1}{y}} , ( \frac{Y}{100} > 0.008856 ) \\ \frac{7.787 * Y}{100} + \frac{16}{116} , ( \frac{Y}{100} \leq 0.008856 )\end{matrix} \\ {var}_{—} Z = \{ \begin{matrix}{( \frac{Z}{108.883} )}^{\frac{1}{z}} , ( \frac{Z}{108.883} > 0.008856 ) \\ \frac{7.787 * Z}{108.883} + \frac{16}{116} , ( \frac{Z}{108.883} \leq 0.008856 )\end{matrix}$$

The luminous source of the LED light source 3 is arranged to brighten in accordance with the order of L1, L2, and L3, and the integral time is increased as far as possible under the guarantee that the single point silicon detector 4 does not overflow. Each light source is provided to maintain a luminous for 1 ms, and then the next light source is lit, and the lights are turned on once every 1 minute. Spiral pipe 9 is placed in constant temperature water of 25° C. to ensure a constant temperature of summer-autumn tea concentrate.

FIG. 4 is the distribution of color changes for summer Green Tea concentrate in the CIE L*a*b* color space. In the graph, the points in the range of moderate oxidation have been moderately oxidized and can be stopped. The range of moderate oxidation in the diagram is obtained by the following way: firstly, selecting 20 samples that are defined as moderately oxidized by review experts and dissolve them into the concentration of oxidation process respectively that can be detected the L*a*b* value with the above method. Then calculate the average of each component's L * a * b * value for every sample and get the coordinates of the mean point in L*a*b* 3D color space. Calculate the Euclidean distance between the point and the mean point of each sample's L*a*b* value in the L*a*b* three dimensional color space and draw a sphere as the range of moderate oxidation with the maximum distance as the radius and the mean point as the center of the sphere.

1. A method that converts summer-autumn tea concentrate to instant powdered black tea wherein said method comprises the following steps: S1: installing a gas-liquid mixed pipeline circuit and color detection pipeline loop on a summer-autumn tea liquid storage tank; S2: summer-autumn tea concentrate in the gas-liquid mixed pipeline loop is mixed with the-airflow and then flows along the gas-liquid mixed pipeline loop back to the summer-autumn tea liquid storage tank; a color detection device of summer-autumn tea concentrate is installed on the color detection pipeline loop and the summer-autumn tea concentrate in the color detection pipeline loop flows back to the summer-autumn tea liquid storage tank after having extracted therefrom a chromatic value by the color on-line detection device; S3: reading the extracted chromatic value of the summer-autumn tea concentrate and closing the gas-liquid mixed pipeline loop if the chromatic value is in a range of a target color value, otherwise, returning to step S2.

2. The method according to claim 1, characterized in that the gas-liquid mixed pipeline loop comprises a length of a spiral pipe, and the summer-autumn tea concentrate flows in the spiral pipe at a high speed after having been mixed with airflow.

3. The method according to claim 1, characterized in that the color on-line detection device comprises a flash frequency LED light source, a color detection channel, a single point silicon detector and a control terminal; wherein the flash frequency light source and the color detection channel are connected to the single point silicon detector, which in turn, is connected to the control terminal.

4. The method according to claim 3, characterized in that the flash frequency LED light source is a hollow sphere with three groups of luminous bodies inside, and each group of luminous bodies composed of three kinds of light sources, red, green and blue, which are in the same ring; the light path of the color detection channel and the single silicon detector passes through the ring center surrounded by a luminous body inside the hollow sphere.

5. The method according to claim 4, characterized in that each group of luminous bodies brightens for 1 ms in accordance with the color of red, green, and blue respectively and repeats once every 1 minute.

6. A device that converts summer-autumn tea concentrate to instant powdered black tea wherein said device comprises a summer-autumn tea concentrate liquid storage tank, which is characterized in that the liquid storage tank is equipped with a gas-liquid mixing pipe loop and color pipeline detection circuit; wherein the gas-liquid mixing pipe loop has installed thereon a diaphragm liquid pump that can extract summer-autumn tea concentrate from the liquid storage tank, and a diaphragm air pump that can compress air, wherein the color detection pipeline loop is provided with a micro peristalsis pump, a flow meter and a color detection channel, wherein two ends of the color detection channel are respectively provided with a flash frequency LED light source and a single point silicon detector and wherein the single point silicon detector is operatively connected to the control terminal.

7. The device according to claim 6, characterized in that the gas-liquid mixing pipe loop is also installed with a coiled pipe, and the summer-autumn tea concentrated liquid and air can be pressed into a spiral pipe at a high speed after they mix with each other.

8. The device according to claim 6, characterized in that the color detection channel, the flash frequency LED light source and the single point silicon detector are connected by straight fiber.

9. The device according to claim 8, characterized in that an outer horizontal direction of the color detection channel is provided with two interface flanges that are used to connect the straight fiber an interior of the color detection channel is provided with a quartz plate, and upper and the lower of the quartz plate are respectively provided with a hose interface for connecting a rubber hose; wherein an outer wall of the outer color detection channel and an outer wall of the quartz plate are inlaid with two collimator lenses, and wherein the single point silicon detector and control terminal are connected by wireless.

10. The device according to claim 8, characterized in that the flash frequency LED light source is a hollow sphere with at least two groups of luminous bodies inside and each group of luminous bodies is composed of three kinds of light sources, red, green and blue, in the same ring and wherein an axis line of straight fiber passes through the ring center surrounded by luminous bodies inside the hollow sphere.
